(19) United States
(12) Patent Application Publication
(10) Pub. No.: US 2021/0102274 A1
(43) Pub. Date: Apr. 8, 2021

(54) DOPANT ALLOYING OF TITANIUM TO SUPPRESS OXYGEN REDUCTION CATALYSIS

(71) Applicant: The Government of the United States of America, as represented by the Secretary of the Navy, Arlington, VA (US)

(72) Inventors: Steve Policastro, Waldorf, MD (US); Derek Horton, Alexandria, VA (US); Carlos Hangarter, Alexandria, VA (US); James A. Wollmershauser, Alexandria, VA (US); Rachel Anderson, Alexandria, VA (US)

(73) Assignee: The Government of the United States of America, as represented by the Secretary of the Navy, Arlington, VA (US)

(21) Appl. No.: 17/120,347

(22) Filed: Dec. 14, 2020

Related U.S. Application Data
(62) Division of application No. 15/380,098, filed on Dec. 15, 2016, now abandoned.
(60) Provisional application No. 62/267,457, filed on Dec. 15, 2015.

(51) Int. Cl. C22C 14/00

(52) U.S. Cl. CPC C22C 14/00

(57) ABSTRACT

An alloy having the formula Ti₁₋ₓMₓ. M is Co, Sn, Cr, or a combination. The value x is from 0.001 to 0.02. A method of combining titanium metal and a dopant metal to form the alloy.

This application is a divisional application of U.S. application Ser. No. 15/380,098, filed on Dec. 15, 2016, which claims the benefit of U.S. Provisional Application No. 62/267,457, filed on Dec. 15, 2015. The provisional application and all other publications and patent documents referred to throughout this nonprovisional application are incorporated herein by reference.

### TECHNICAL FIELD

The present disclosure is generally related to titanium alloys.

### DESCRIPTION OF RELATED ART

Galvanic corrosion generally refers to the corrosion damage that occurs when two dissimilar metals are electrically connected in the presence of a corrosive electrolyte (Jones, Principles and Prevention of Corrosion, Upper Saddle River, N.J.: Prentice Hall, 1996, pp. 229-230; Mansfeld et al., “Galvanic corrosion of Al alloys—I. Effect of dissimilar metal” Corrosion, vol. 30, pp. 343-353, 1974; Mansfeld et al., “Galvanic corrosion of Al alloys—II. Effect of solution composition” Corrosion Science, vol. 15, pp. 183-198, 1975). It has been observed that titanium-alloy fasteners contribute to increased corrosion in structural aluminum alloys, on aircraft exposed to the environment, due to galvanically driven corrosion (Matzdorf et al., “Galvanic test panels for accelerated corrosion testing of coated al alloys: part I—concept” Corrosion, vol. 69, pp. 1240-1246, 2013; Feng et al., “Galvanic test panels for accelerated corrosion testing of coated al alloys: part II—measurement of galvanic interaction” Corrosion, vol. 70, pp. 95-106, 2014). The corrosive electrolytes in atmospheric environments are aqueous in nature; that is, water acts as the solvent for various ionic and gaseous constituents that then impact anodic and cathodic reaction rates. The ionic components of the atmospheric electrolytes are commonly the result of various kinds of salt aerosols while the gaseous constituents (CO₂, etc.) diffuse in at the electrolyte-atmosphere boundary (Nishikata et al., “Influence of electrolyte layer thickness and pH on the initial stage of the atmospheric corrosion of iron” Journal of the Electrochemical Society, vol. 144, pp. 1244-1252, 1997; Vera Cruz et al., “Pitting corrosion mechanism of stainless steels under wet-dry exposure in chloride-containing environments” Corrosion Science, vol. 40, pp. 125-139, 1998; Wang et al., “Atmospheric corrosion of aluminium alloy 2024-T3 exposed to salt lake environment in Western China” Corrosion Science, vol. 59, pp. 63-70, 2012; Young et al., “Stages of damage evolution for al 2024-T3 around fasteners in marine atmosphere” Corrosion, vol. 71, pp. 1278-1293, 2015).

Aqueous corrosion, both fully immersed and atmospheric, requires a coupled oxidation-reduction reaction, which may occur on neighboring regions on the same surface, an electronic conduction path, and the aforementioned water-based electrolyte for ionic transport between the reaction sites. In the case of galvanic corrosion, the dominant sites for metal oxidation and oxygen reduction are located on the different materials of the galvanic couple; thereby requiring the establishment of an electron conduction path that extends:
From the oxidation site
Through the bulk of the active metal or alloy
Across the galvanic junction
Through the bulk of the noble metal or alloy
Across the noble metal oxide
To the reduction reaction site

In the case of electrolytes that arise from atmospheric processes, the electrolyte is usually aqueous, thin, and may be localized on the surface. Chemistries and pH in the electrolyte can vary greatly and the oxygen content of the electrolytes can be high. The discrete nature of the atmospheric electrolyte makes cathodic protection difficult and galvanic corrosion damage under these conditions can be difficult to detect. FIG. 1 illustrates the components and processes of atmospheric galvanic corrosion. The junction of the two plates of metal 1 with a noble metal fastener establishes the galvanic junction of dissimilar metals that can cause corrosion once a droplet of water forms on the surface. The high surface area-to-volume ratio of the droplet allows a high dissolved oxygen concentration to obtain even once the reduction reaction begins consuming oxygen. As a result, the electrolyte near the cathode becomes alkaline while the electrolyte near the anode becomes more acidic.

The corrosion rate of the more active material in a galvanic couple is strongly influenced by such conditions as the presence of aggressive anions, the amount of exposed surface area of the cathode and by the ability of the cathode to support a suitable reduction reaction, including hydrogen evolution and oxygen reduction as shown in Table 1 (Hamannet al., Electrochemistry, Weinheim: Wiley-VCH, 1998; Curioni et al., “The Mechanism of Hydrogen Evolution during Anodic Polarization of Aluminium” Electrochimica Acta, vol. 180, pp. 712-721, 2015). In the case of noble fasteners in structural materials, the overall corrosion damage is determined by, among other influences, the ability of the noble materials to support cathodic reactions (Mansfeld et al., “Galvanic corrosion of bare and coated Al alloys coupled to stainless steel 304 or Ti-6A1-4V” Corrosion Science, vol. 13, pp. 605-621, 1973; Zhang et al., “Transitions between pitting and intergranular corrosion in AA2024” Electrochimica Acta, vol. 48, pp. 1193-2010, 2003; Zhou et al., “Study of localized corrosion in AA2024 aluminium alloy using electron tomography” Corrosion Science, vol. 58, pp. 299-306, 2012). The two reduction reaction rates are themselves influenced by the concentrations of the reacting species in the electrolyte and by the catalytic properties of the material surface. In the case of the oxide on titanium, the electronic structure plays an important role in determining the kinetics of the reduction reactions.

TABLE 1
Reactions, pH ranges, and potential ranges for reduction reactions

| Reaction | pH range | Potential range (V_{SHE}) |
|---|---|---|
| $\frac{1}{2} {O}_{2} + {H}_{2} O + 2 {e}^{-} ↔ 2 {OH}^{-}$ | 7-14 | +0.820 − +0.401 |
| 2H₂O + 2e⁻ [symbol] H₂ + 2OH⁻ | 7-14 | −0.413 − −0.828 |

### BRIEF SUMMARY

Disclosed herein is a composition comprising: an alloy having the formula Ti₁₋ₓMₓ. M is a dopant selected from Co, Sn, Cr, and combinations thereof. The value x is from 0.001 to 0.02.

Also disclosed herein is a method comprising: combining titanium metal and the dopant metal to form the above alloy.

### BRIEF DESCRIPTION OF THE DRAWINGS

A more complete appreciation will be readily obtained by reference to the following Description of the Example Embodiments and the accompanying drawings.

FIG. 1 shows an illustration of galvanic corrosion in an atmospheric environment.

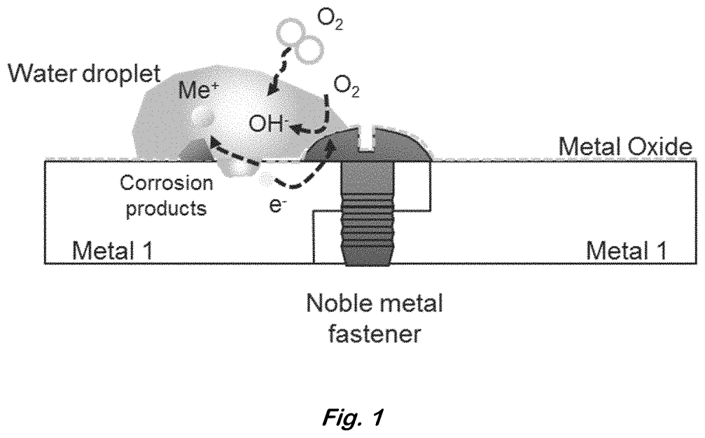

FIG. 2 shows a representation of the metal oxide-electrolyte interface as an n-type semi-conductor energy-level diagram overlaid on an array of redox potentials.

FIG. 3 shows a schematic illustration of the simplified solution-oxide-metal system.

FIG. 4 shows ORR reaction energies for four different surface sites (labeled 1-4) plotted at an applied potential of 0 and 1.23 VSHE. The intermediates correspond to the reactions in Eqs. (1)-(4). The four curves from top to bottom are Site 2, Site 3, Site 4, and Site 1.

FIG. 5 shows a Sabatier volcano plot of computationally predicted dopant overpotentials. Dopants that were predicted and tested are V(III), Mn(II), Cr(III), Co(II), Ag(I), Undoped, Sn(IV), V(V), and Al(III), and dopants not yet experimentally verified are Ni(III), Nb(V), Cu(II), Ge(IV), Zn(II), Ga(III), and Si(IV).

FIG. 6 shows a plot of annealed alloy unit cell volume as a function of dopant concentration for Ti—V, Ti—Sn, Ti—Co, and Ti—Cr alloys as determined by XRD.

FIG. 7 shows plots of the cathodic polarization curves for Ti and the three binary alloys: Ti₉₉Co₁, Ti₉₉Sn₁, and Ti₉₉Cr₁, in 0.6 M NaCl+0.01 M KOH solution, highlighting regions of the current response to the applied potential where different reaction mechanisms were dominant. The four curves from top to bottom on the left are Ti₉₉Co₁, pure Ti, Ti₉₉Cr₁, and Ti₉₉Sn₁.

FIG. 8 shows a plot of |Z_{imag}| vs. frequency for pure titanium and the three titanium alloys in 0.1 M KOH. The single time constant response to the voltage perturbation suggests that a constant-phase element equivalent circuit is applicable for capturing the oxide behavior.

FIG. 9 shows a Mott-Schottky plot of C⁻² vs. applied potential for Ti and the three binary alloys: Ti₉₉Co₁, Ti₉₉Sn₁, and Ti₉₉Cr₁ in 0.1 M KOH solution.

FIG. 10 shows a plot of Imod as a function of frequency for the pure titanium sample for light wavelengths from 310 nm to 1450 nm and modulation frequencies from 5000 Hz to 0.1 Hz.

FIG. 11 shows overlays of the photoelectrochemical responses of pure Ti, Ti₉₉Co₁, Ti₉₉Sn₁, and Ti₉₉Cr₁ to 310 nm wavelength UV light with modulation frequencies from 5000 Hz to 0.1 Hz.

FIG. 12 shows a plot of current density vs. potential for pure Ti, Ti₉₉Co₁, Ti₉₉Sn₁, and Ti₉₉Cr₁ in 0.6 M NaC1 with 0.01 M KOH at 1600 RPM with a scan rate of 5 mV/s.

FIG. 13 shows an equivalent circuit diagram for a constant-phase-element model of a metal oxide-solution interface.

FIG. 14 shows an example Mott-Schottky plot of 1/C² vs. potential for Ti₉₉Cr₁. Expressions for the slope and intercept are given that are related to the flatband potential and donor density.

FIG. 15 shows normalized Imod as a function of photon energy for the oxide on Ti₉₉Sn₁.

FIG. 16 shows a plot of (I_{mod}×hv)^{0.5} vs. photon energy for the different oxides. The linear best-fit line for each oxide was determined by fitting through the (I_{mod}×hv)^{0.5} values from 3.5 eV to 2.7 eV.

FIG. 17 shows the overlay of band energies for the various oxides on redox potentials to illustrate reduction reactions that can be catalyzed on the oxides by electrons supplied from corrosion oxidation reactions.

FIG. 18 shows cathodic polarizations scans of the undoped titanium and all of the 1 at % doped titanium samples. The curves from top to bottom on the left are undoped, Sn, Cr, V, Ag, Co, Mn, and Al.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed is a method to alter the electronic structure of the native oxides formed on titanium by doping (alloying in low concentrations) with specific elements, such as chromium and tin, in order to disrupt the oxygen reduction reaction (ORR) and inhibit corrosion in galvanic couples with these doped alloys.

Many structural aircraft alloys, such as AA2024 and AA7075, have stable, corrosion resistant oxides. However, corrosion damage is frequently seen in areas that are near galvanic contacts between the aluminum alloys and fasteners made of titanium or steel alloys. The fastener material, which is more noble than the aluminum, catalyzes the reduction reaction from species present in the electrolyte and drives oxidation in the structural alloy.

The corrosion rate of the more active material is strongly influenced by the exposed surface area of the cathode and by the ability of the noble material to support a suitable reduction reaction such as hydrogen evolution or oxygen reduction. These two reduction reaction rates are themselves influenced by the concentrations of the reacting species in the electrolyte and by the catalytic properties of the material surface. Of particular interest are metal oxides in which the oxide microstructure plays a role in affecting the kinetics of the reduction reactions.

The protective oxide that forms on titanium is of interest because it is thermodynamically stable up to +1.5 V_{SHE} (+1.25 V_{SCE}) at pH 12 (Pourbaix, Atlas of Electrochemical Equilibria in Aqueous Solutions, Houston: NACE, 1974). For the alkaline conditions expected when acting as the noble material in a galvanic couple, the electrochemical properties of the oxide dominate the metal's cathodic behavior. In an alkaline environment, both oxygen reduction and the hydrogen evolution reactions are expected to be catalyzed on the oxide.

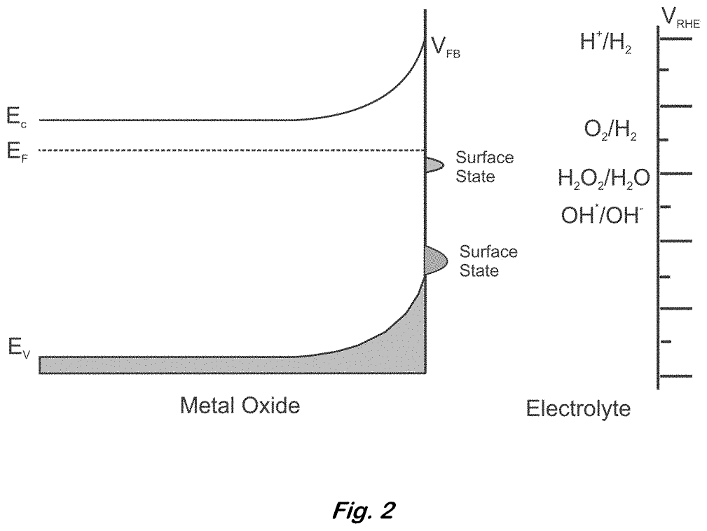

FIG. 2 illustrates a general framework for considering a metal oxide-electrolyte system (Rajeshwar, “Charge transfer in photoelectrochemical devices via interface states: unified model and comparison with experimental data” Journal of the Electrochemical Society, vol. 129, pp. 1003-1008, 1982). The natively-formed metal oxide is represented by the energy-level diagram of an n-type semi-conductor. The electrolyte is represented by a line of relative redox potentials and adsorbed surface states at the oxide-electrolyte interface. Electrons released in the oxidation reaction are presumed to travel across the galvanic junction and eventually scatter into the noble metal oxide conduction band and then into an adsorbed surface state in order to participate in the requisite reduction reaction.

This framework raises the question to what extent the electrons scattered into the conduction band can be trapped or disrupted from crossing the oxide-electrolyte interface and thereby prevented from participating in reduction reactions. As an example, some microstructural defects in titanium oxide are known to act as traps for photoexcited electrons, thereby inhibiting catalysis (Muhich et al., “Increasing the photcatalytic acitivity of anatase TiO₂ through B, C, and N doping” Journal of Physcial Chemistry C, vol. 118, pp. 27415-27427, 2014). The approach taken here for creating microstructural defects in the titanium oxide band structure was to introduce dopant atoms of different valence states or radii into the titanium oxide in order to disrupt reduction reaction rates and thereby reduce the active metal corrosion rate in associated galvanic couples.

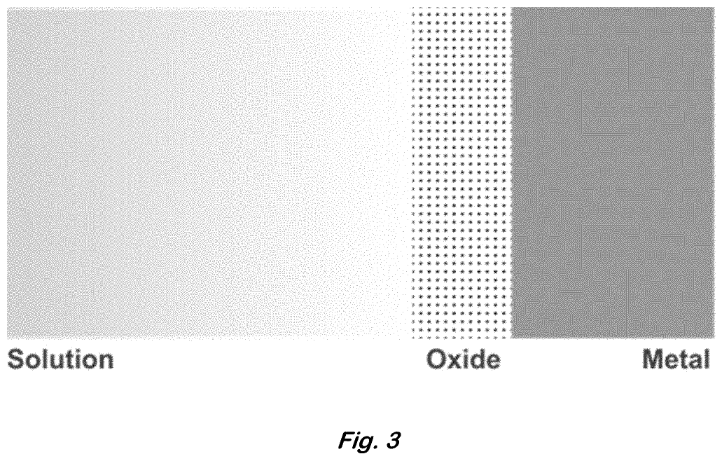

Pure titanium was selected because, as a valve metal, it formed a very stable oxide that was well characterized and the titanium alloy, Ti 6Al -4V, has numerous aircraft applications. The oxide that forms on pure titanium is thermodynamically stable up to a range of ˜+1.6-+1.4 V_{SHE} (+1.36 -+1.16 V_{SCE}) for pH 10-13 and, thus, for the alkaline conditions expected to obtain when acting as the noble material in a galvanic couple, the electrochemical properties of the oxide dominate its cathodic behavior. A schematic illustration of the electrochemical system is shown in FIG. 3.

Computer simulations of oxygen reduction reactions on various transition metal oxides (Man et al., “Universality in oxygen evolution electrocatalysis on oxide surfaces” ChemCatChem, vol. 3, pp. 1159-1165, 2011) suggested that cobalt, tin, and chromium would be useful elements to consider as alloying elements in titanium. The electrochemical properties of the oxides of the various alloys were investigated using potentiodynamic polarization, rotating-disk-electrode (RDE) cyclic voltammetry, electrochemical impedance spectroscopy (EIS), Mott-Schottky (MS) tests, and intensity modulated photocurrent spectroscopy (IMPS) experiments.

Computational chemistry was used to obtain guiding design principles. Computational catalysis studies often report calculable thermodynamic descriptors and Sabatier volcano curves to identify optimal catalysts near the top of the activity volcano (see e.g., Norskov et al., J. Phys. Chem. B 2004, 108, 17886-17892; Fabbri et al., J. Catal. Sci. Tech. 2014, 4, 3800-3821; Greeley et al., Energy Environ. Sci. 2012, 5, 9246-9256; Morales-Guio et al., Chem. Soc. Rev. 2014, 43, 6555-6569.). While this level of modeling works well in predicting dopants that maximize the catalytic activity of a material, it remains an open question if these in silico models are also robust for predicting dopants that minimize catalytic activity, i.e. dopants that lie near the bottom of the Sabatier volcano plots. This work confirms that computational catalysis modeling is also robust in this regime. Disclosed is an integrated computational and experimental study that demonstrates that simple Sabatier volcano descriptors can be used to identify metal dopants that decrease oxygen reduction currents by as much as 77% when impregnated in amorphous TiO₂ at doping concentrations of 1%.

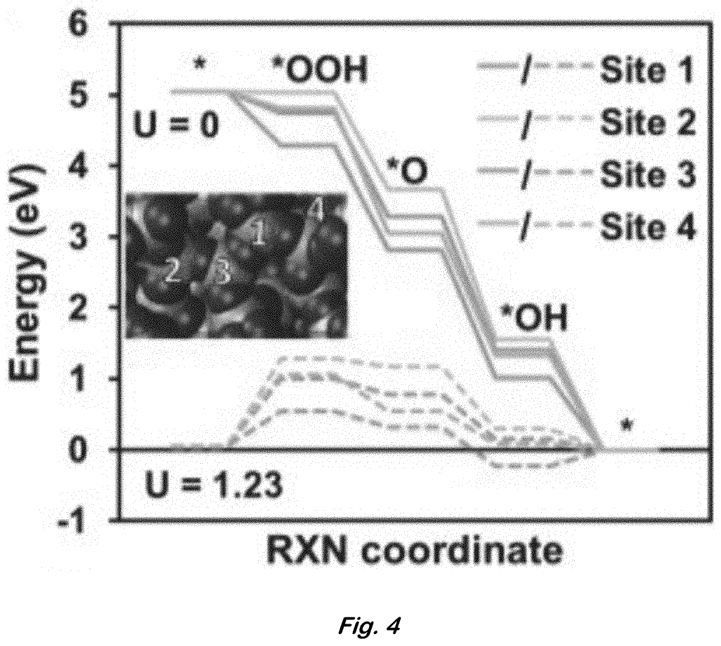

Calculating reaction overpotentials with the computational hydrogen electrode model (Norskov et al., J. Phys. Chem. B 2004, 108, 17886-17892) is routinely the first step toward understanding electrocatalytic activity. Although this model is not normally used for calculating reaction barrier heights and rate constants, it can yield robust insight into trends in electrocatalytic reaction rates. This methodology was used to calculate reaction overpotentials for the dissociative ORR mechanism shown. (The symbol “*” denotes an empty surface site on the material.) Because the hydrogen evolution reaction (½H₂ [symbol] H⁺+e⁻) is in equilibrium at 0 V vs. the standard hydrogen electrode (VSHE), the energies of protons and electrons in electrochemical reduction steps were modeled as half the energy of an H₂ molecule plus a linear energy correction to account for an applied potential. Using these energy corrections, the theoretical reaction overpotential was calculated by finding the applied potential at which all four reaction steps are downhill in energy. Mathematically, this was determined by the most uphill reaction step at the equilibrium potential for the ORR (1.23 VSHE). For example, sites 1-4 in FIG. 4 had predicted overpotentials of 0.50, 0.95 1.01, and 1.24 V.

*+O₂+H⁺+e⁻ [symbol] *OOH (1)

*OOH+H⁺+e⁻ [symbol] *O+H₂O (2)

*O+H⁺+e⁻ [symbol] *OH (3)

*OH+H⁺+e⁻ [symbol] *+H₂O (4)

Calculated energies from Kohn-Sham density functional theory (DFT) were obtained using the Vienna ab initio simulation package (VASP) (Kresse et al., J. Phys. Rev. B 1996, 54, 11169-11186; Kresse et al., J. Comput. Mater. Sci. 1996, 6, 15-50; Kresse et al., J. Phys. Rev. B 1994, 49, 14251-14269; Kresse et al., J. Phys. Rev. B 1993, 47, 558-561) utilizing the Perdew-Burke-Ernzerhof (PBE) (Perdew et al. Phys. Rev. Lett. 1996, 77, 3865-3868; Perdew et al., Phys. Rev. Lett. 1997, 78, 1396-1396) GGA exchange correlation functional and the projector augmented wave (PAW) method (Blochl, Phys. Rev. B 1994, 50, 17953-17979; Kresse et al., Phys. Rev. B 1999, 59, 1758-1775) with spin polarization. Planewave energy cutoffs of 450 eV and a 2×2×1 k-point grid gave well-converged intermediate energies. The zero point energy, entropic, and solvation free energy contributions were approximated by using the values predicted by Valdes et al., J. Phys. Chem. C 2008, 112, 9872-9879 for the ORR intermediates adsorbed to TiO₂.

An atomistic reactive forcefield (ReaxFF) (Kim et al., Langmuir 2013, 29, 7838-7846; van Duin et al., J. Phys. Chem. A 2001, 105, 9396-9409) was used to create an amorphous oxide surface model as had been done by others (Ewing et al., Langmuir 2014, 30, 5133-5141). Crystalline TiO₂ surfaces were annealed using ReaxFF (Aktulga et al., Parallel Comput. 2012, 38, 245-259) as implemented in LAMMPS, (Plimpton, Comput. Phys. 1995, 117, 1-19) and the resulting annealed structure was then geometrically relaxed using Kohn-Sham density functional theory (DFT) calculations as described below. Unit cells of these systems containing about 160 atoms were found to reasonably match experimental x-ray diffraction patterns for TiO₂ nanoparticles showing this to be a reasonable model for an amorphous TiO₂ surface (Petkov et al., Non-Cryst. Solids 1998, 231, 17-30). On this surface, four possible sites were found accessible for ORR catalysis (FIG. 4). Modeling the ORR reaction energies on these four sites yielded overpotentials that vary by nearly 0.8 V, but the most active site (Site 1) had a predicted overpotential in good agreement with the experimental overpotential for TiO₂ (η_{predicted}^{ORR}=0.5 V and =ηₑₓₚ^{ORR} 0.45 V) (Arashi et al., Catal. Today 2014, 233, 181-186). This validated that the amorphous TiO₂ model could be used to study ORR mechanisms.

Different metal dopants were considered that could be introduced into the oxide to increase ORR overpotentials. Each dopant atom was embedded into the surface at its preferred oxidation state given by experimental Pourbaix diagrams (Takeno, Geological survey of Japan open file report 2005, 419, 1-102) at the corrosion experiment operating conditions, −0.8 V vs the saturated calomel electrode (VSCE) at pH 12. The stability of each dopant was compared at all four different active sites shown in FIG. 4 to identify the most stable substitution site. It was assumed that the most thermodynamically stable site would reflect the atomic configuration that would be least likely to reconstruct and therefore participate in electrochemical ORR. Following work by Carter and co-workers (Liao et al., J. Am. Chem. Soc. 2012, 134, 13296-13309), the maximum impact of each dopant on the ORR activity was predicted by modeling the ORR intermediates adsorbed directly to the dopant atom embedded in the amorphous surface at its most stable site.

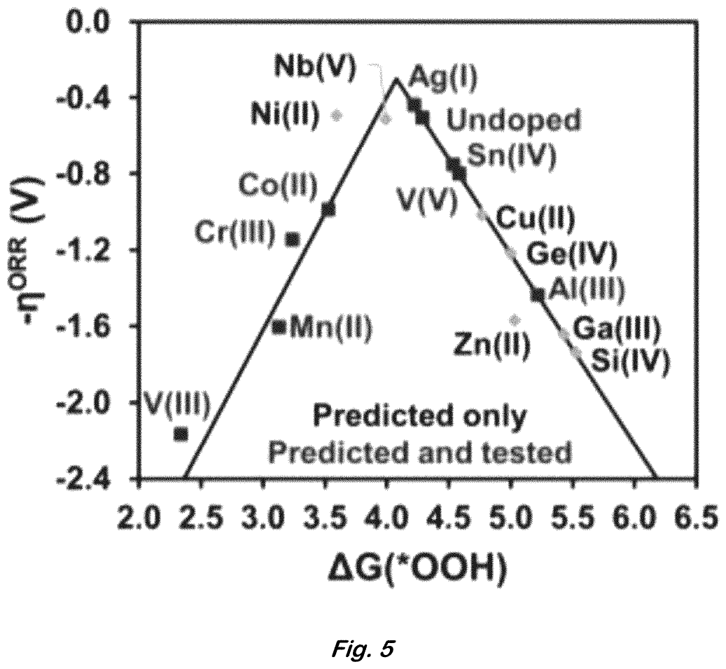

The predicted overpotential for each metal dopant is displayed in a Sabatier volcano diagram (FIG. 5). Unlike work in fuel cell catalysis where the ideal catalyst is found at the top of the activity volcano, dopants at the bottom of the volcano that would optimally reduce ORR rates are or more interest. Even though the ORR overpotential directly on the doped site was calculated, the reaction activity will be controlled by the most active sites on the surface. It is known that dopants in oxides can affect adsorbate binding energies multiple sites away (Liao et al., J. Am. Chem. Soc. 2012, 134, 13296-13309). However, the influence of the dopant on the overpotential is expected to decrease when the dopant is further away from the binding site. Thus, even though the overpotential is site dependent and not all of the sites will have as high an overpotential as shown in FIG. 5, the overall trend for how dopants affect ORR activity will be reflected by the activity volcano.

The alloys include titanium and a dopant metal that may be any of cobalt, tin, chromium, aluminum, manganese, vanadium, silver, any other metal disclosed herein, any other metal that reduces galvanic corrosion when used as described herein, or any combination of these metals. The alloy may be free of any other metals, or it may contain a trace amount of contaminating metals. The contaminants may be present in an amount less than the total molar amount of the dopant, less than 1 mol %, or less than 0.1 mol %. The alloy has the formula Ti₁₋ₓMₓ, where M is the dopant or dopants and x is from 0.001 to 0.02, or from 0.005 to 0.015. The alloy may have the formula Ti₉₉M₁. The alloy may be included in a composition that is at least 90 or 99 wt % of the alloy. The alloys may be made by the methods disclosed herein or by any other method for producing alloys.

As titanium tends to oxidize on exposure to air, an article made from the alloy or a composition containing the alloy will have an oxide on its surface. The oxide includes atoms of both titanium and the dopant. Such an article may be a fastener such as a bolt or a screw.

When the fastener is used for fastening metal components, it will typically be positioned in electrical contact with one of the metal components. Electrolytes, such as aqueous electrolytes, may come in electrical contact with both the fastener and the metal component. For example, rainwater or condensation may collect to form a droplet electrical connecting the metal component and the fastener. When the metal component has a lower electrode potential in the electrolyte than titanium, galvanic corrosion may occur in the metal. However, the amount of corrosion is reduced due to the presence of the dopant.

An advantage of this process is that the titanium oxide spontaneously forms on contact with air because of the high reactivity of pure titanium and the oxide is very tough so that it is resistant to damage and can re-form on its own. In addition, by bulk alloying the desired dopant atoms, the dopant atoms are incorporated into the oxide when it forms, rather than needing to be reapplied from the outside.

The following examples are given to illustrate specific applications. These specific examples are not intended to limit the scope of the disclosure in this application. Titanium (99.995% purity) and Ti-based minor solute alloy ingots were produced at solute concentration of 1 at % using the arc-melting technique using high purity metals (Co 99.995%, Sn 99.999%, Cr 99.996%). Ingots were subsequently suction cast into a custom copper mold consisting of two cylindrical regions of 1 cm and 0.6 cm diameter the latter for RDE test specimens, which were then machined and ground to 4 mm discs of 5.05 mm diameter. After casting and machining, for Ti, Ti₉₉Sn₁, and Ti₉₉Cr₁, a four hour solution anneal at 827° C., within the single phase HCP region, was performed followed by a water quench. In the case of Ti₉₉Co₁, a four hour solution anneal at 685° C. was used due to the shift in the HCP single phase field to a lower temperature and lower solubility (Murray, “The Co—Ti(Cobalt-Titanium) system” Bulletin of Alloy Phase Diagrams, vol. 3, pp. 74-85, 1982). Similar alloys of Ag, Al, Mn, and V were also made by the same or similar methods. X-ray diffraction, Cu k-alpha, was used to verify single phase structure and determine the lattice coefficients using whole pattern fits. Prior to electrochemical testing, samples were polished in successively finer grits to 1200 grit using SiC paper. For baseline electrochemical testing, samples were mounted in insulating epoxy.

Potentiodynamic polarization characterization of the various titanium alloys was performed in 0.6 M NaCl+0.01M KOH (pH 12) electrolyte with a platinum wire counter electrode and a saturated calomel reference cell. The titanium alloy oxides were equilibrated at room temperature and ambient aeration for 1 hour. After an 18-hour open circuit (OC) hold, the potentiodynamic polarizations were performed over a range of potentials starting from +0.02 V above the equilibrium potential to −1.5 V_{SCE} or −2.0 V_{SCE} using a graphite counter electrode. The potentials were stepped at a rate of −0.167 mV/sec.

Electrochemical impedance spectroscopy (EIS) characterization of the various titanium alloys was performed in 0.1 M KOH (pH 13) with a platinum wire counter electrode and a silver-oxide pseudo-reference cell (Austin et al., “Review of fundamental investigations of silver oxide electrodes” United States Army Materiel Commande, Washington, D.C., 1965). The titanium alloy oxides were equilibrated at room temperature and ambient aeration for 1 hour. The EIS scans were performed at the oxides' equilibrium potentials with a 5 mV_{RMS} perturbation at frequencies from 100 kHz to 0.1 Hz.

Mott-Schottky analysis tests of the various oxides were performed in 0.1 M KOH (pH 13) with a platinum wire counter electrode and a silver-oxide pseudo-reference cell. The titanium alloy oxides were equilibrated at room temperature and ambient aeration for 1 hour. The applied DC potentials were stepped in 100 mV increments from +0.5 V_{SCE} to −1.5 V_{SCE}. The oscillating potential was applied at 100 Hz at ±5 mV_{RMS}.

Intensity modulated photocurrent spectroscopy (IMPS) characterization (Peter, “Dynamic aspectgs of semiconductor photoelectrochemistry” Chemical Reviews, vol. 90, pp. 753-769, 1990) of the various oxides was also performed in 0.1 M KOH (pH 13) with a platinum wire counter electrode and a silver-oxide pseudo-reference cell. The titanium alloy oxides were equilibrated at room temperature and ambient aeration for 1 hour. Two potentiostats were used for these characterizations. The primary potentiostat applied the baseline DC current and AC modulation to the LED while the secondary potentiostat received the clock signal from the primary and measured the response of the sample. The AC current supplied to the LED varied in frequency from 5000 Hz to 0.1 Hz while the magnitude of the oscillation was varied to account for the maximum current permitted through the LED. A dozen LEDs, identified by the emitted wavelength with the highest intensity, were used that spanned the spectrum from infrared to ultraviolet light: 1450 nm, 1200 nm, 850 nm, 660 nm, 617 nm, 590 nm, 530 nm, 505 nm, 470 nm, 420 nm, 405 nm, and 310 nm.

Lastly, cyclic voltammetry (CV), using rotating disc electrode (RDE) measurements, of the catalytic activity of the various oxides were performed in 0.6 M NaCl+0.01 M KOH (pH 12) under conditions in which the electrolyte was aerated with pressurized air and de-oxygenated with nitrogen. The discs were rotated at 100, 400, 900, 1600, and 2500 rpm. The potential was scanned at a rate of 5 mV/sec from +0.25 V_{SCE} to −1.75 V_{SCE}.

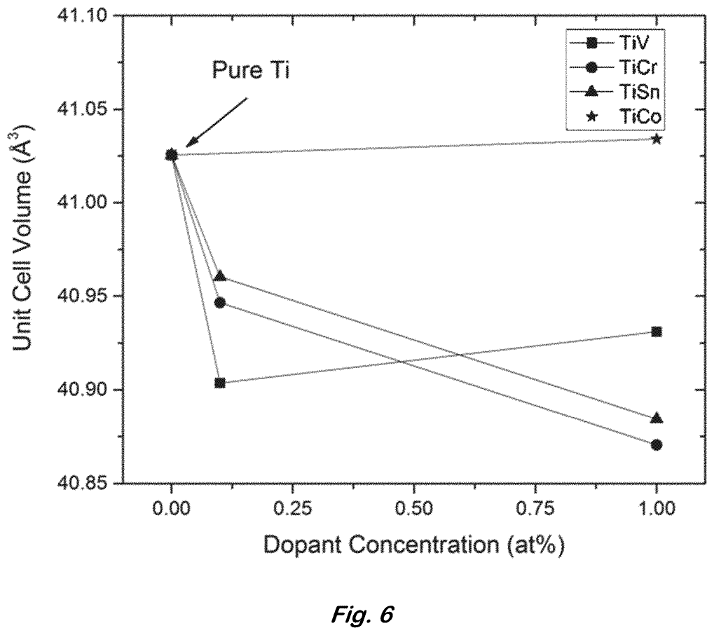

Alloy characterization—Diffraction indicated that annealing Ti, Ti₉₉Sn₁, Ti₉₉Cr₁, and Ti₉₉Co₁ produced a single HCP phase. Unit cell determinations based on the diffraction results is shown in FIG. 6. For alloying additions of Cr and Sn, a clear decrease unit cell volume is seen. In the case of Ti₉₉Co₁, the HCP lattice expands slightly upon alloying likely due to Co having an atomic radius >20% smaller than Ti and adopting an interstitial alloying site. In the case of both Cr and Sn the atomic radii are only slight smaller than Ti (˜13%) and substitutional alloying would likely reduce the unit cell volume. In either case, the trend in unit cell volumes follows Hume-Rothery rules.

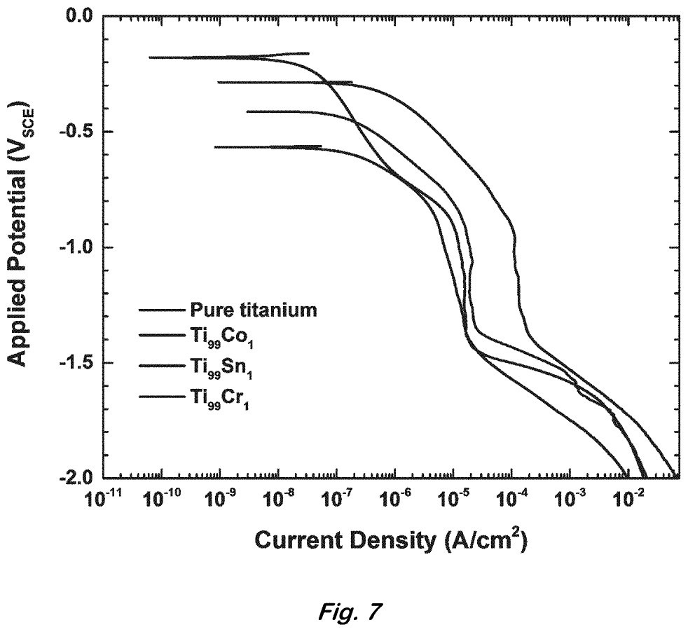

Potentiodynamic polarization scans—Examples of the results from the cathodic polarizations for each of the oxides are shown in FIG. 7. Various regions of the current response of each oxide to the applied potential are indicated on the plot, including the most likely dominant reduction reaction and the most likely controlling mechanism. Each alloy shows clear mixed activation and diffusion control regimes for oxygen reduction at potentials above −1 V_{SCE} and a clearly defined mass transport limited current density at potentials between −1 V and −1.4 V_{SCE} before hydrogen reduction dominates the cathodic reaction at lower potentials. Cathodic current densities of each alloyed titanium show a reduction in the mass transport limiting current density.

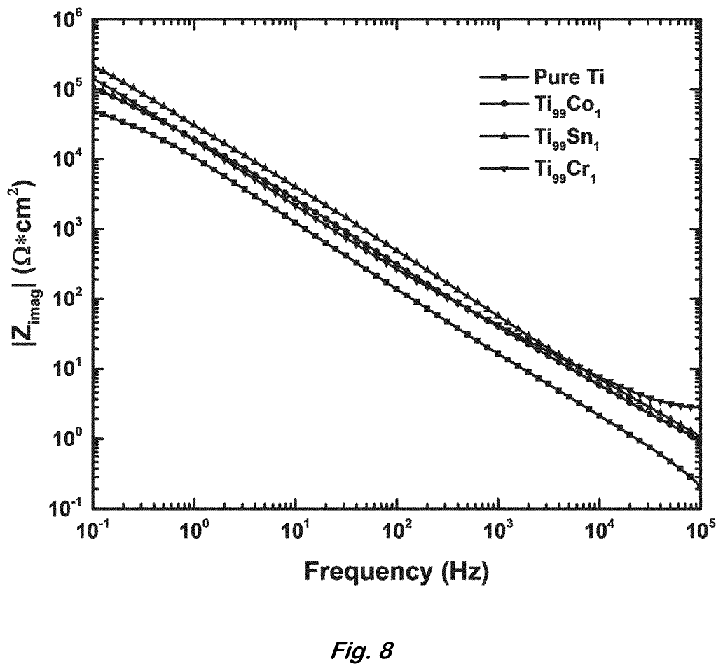

EIS and Mott-Schottky scans—A modified Bode plot of the oxide responses to the EIS scans for pure titanium and the alloys are shown in FIG. 8. |Z_{imag}| is plotted as a function of frequency in order to detect capacitance or inductance effects in the oxide response to the oscillating applied potential. For each alloy, a constant phase element equivalent circuit is applicable for use in analyzing the oxide response.

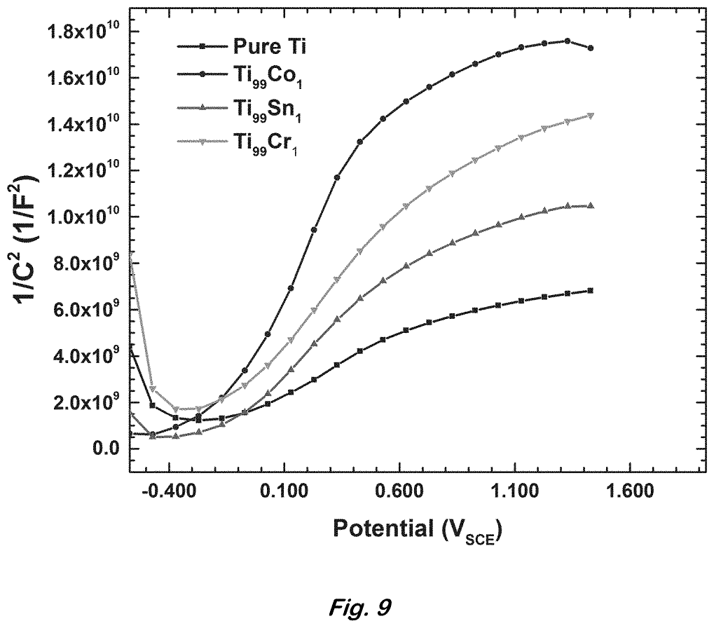

Examples of the results from the Mott-Schottky tests for each of the oxides are shown in FIG. 9. The increases in 1/C² as potential increased from ˜−0.3 V_{SCE} to ˜1.1 V_{SCE} indicate a thickening of the oxide. The maxima in 1/C² for all of the response curves around 1.2 V_{SCE} is most likely due to oxygen formation on the oxide, while the minima near −0.4 V_{SCE} indicate changes in the electronic structure of the oxide.

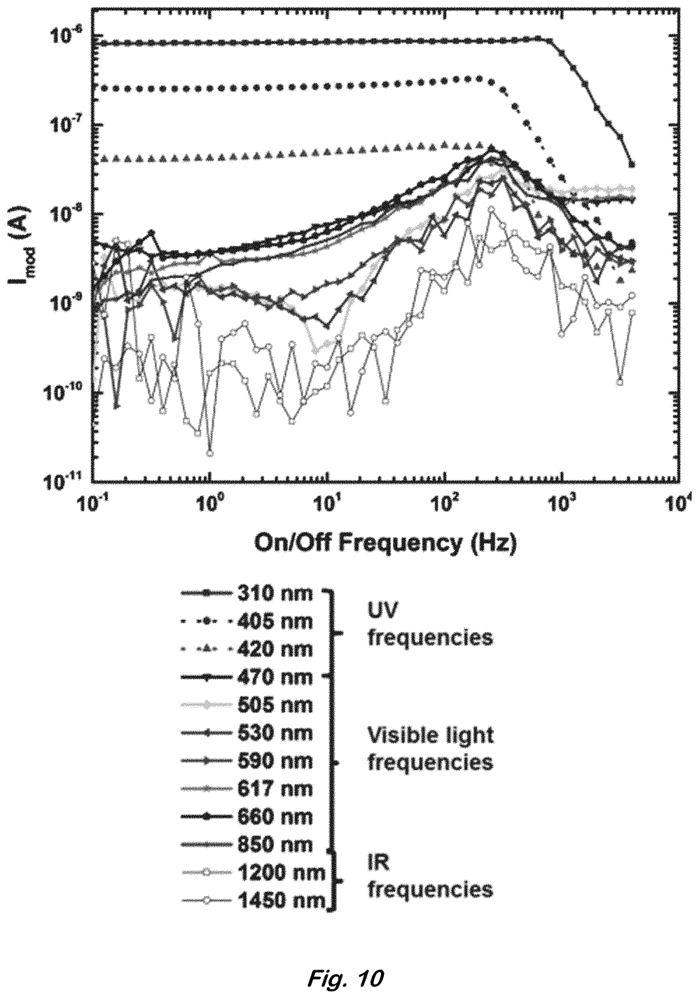

IMPS Scans—The photoelectrochemical response, as a Bode plot representation, of the titanium oxide to a range of photon energies and light modulation frequencies is shown in FIG. 10. The frequency corresponding to the maximum photo-currents indicate time-constants ranging from 2-8×10⁻³ s for electron transport to the interfacial reaction sites under the assumption that the electron-hole recombination rate is slowest at that modulation frequency. The long tails, especially for the ultraviolet wavelengths at the low modulation frequencies indicate that the light intensity was too high.

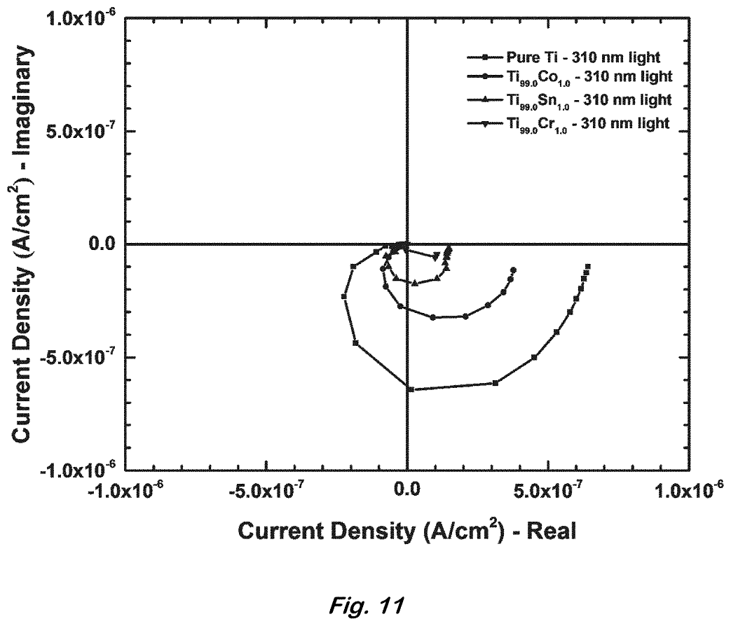

The photoelectrochemical response, using a Nyquist plot representation, of the oxides of pure Ti, Ti₉₉Co₁, Ti₉₉Sn₁, and Ti₉₉Cr₁ to 310 nm wavelength UV light with modulation frequencies from 5000 Hz to 0.1 Hz is shown in FIG. 11. The Nyquist plots are in keeping with the Ponomareve-Peter model for charge transport in the oxide band structure (Ponomarev et al., “A generalized theory of intensity modulated photocurrent spectroscopy (IMPS)” Journal of Electroanalytical Chemistry, vol. 396, pp. 219-226, 1995.

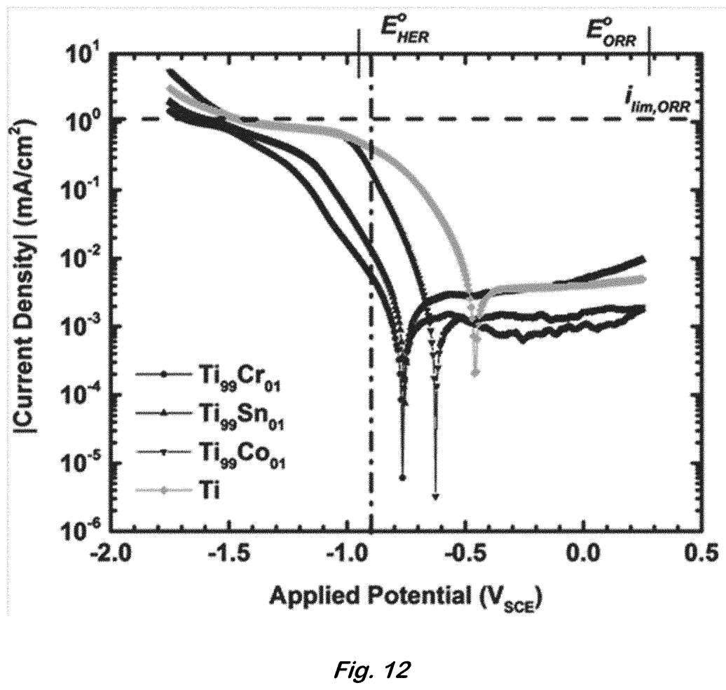

CV measurements—In deoxygenated and aerated environments, portions of the CV scans on pure titanium, Ti₉₉Co₁, Ti₉₉Sn₁, and Ti₉₉Cr₁ are shown in FIG. 12. The cathodic-to-anodic portion of the second potential sweep is shown and the y-axis has a log scale instead of the more usual linear scale for current so that the differences in the currents at the lower potentials can be more easily seen.

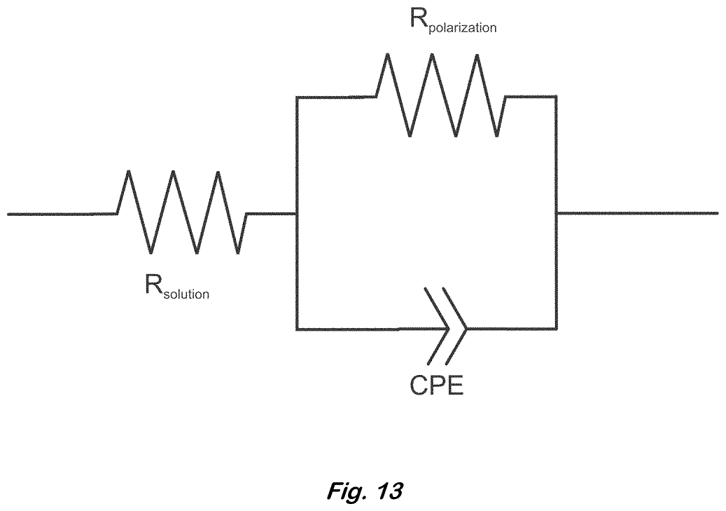

Because only single time constants are present in the EIS responses in FIG. 8, the constant-phase-element (CPE) equivalent circuit model, shown in FIG. 13, can be used to capture the behavior of the oxide. From the equivalent circuit models, values for the solution resistance, charge-transfer resistance, and the constant-phase-element parameters can be obtained, as shown in Table 2. In addition, using Eq. (5), values for oxide capacitance can be calculated and are shown in the final column of Table 2. C represents the oxide film capacitance, R_{P} the charge transfer resistance, Y₀ is the admittance of an ideal capacitor, and a represents an empirical constant to capture the deviation of the CPE from an ideal capacitor.

$$C = \frac{{( {Y}_{0} {R}_{p} )}^{\frac{1}{α}}}{{R}_{p}} \qquad ( 5 )$$

TABLE 2
Values determined from a CPE equivalent circuit model fit to
EIS data obtained from pure titanium oxide and oxides of titanium
alloys along with the calculated oxide film capacitance

| | | | | Calculated |
|---|---|---|---|---|
| | Fit Parameter | | | Capacitance |
| Metal Oxide | α | Y₀ (S*s^{α}) | R_{P} (kΩ) | (μF) |
| Pure Ti | 0.931 | 22.21 × 10⁻⁶ | 85.4 | 8.4 |
| Ti₉₉Co₁ | 0.890 | 12.61 × 10⁻⁶ | 267.5 | 2.7 |
| Ti₉₉Sn₁ | 0.909 | 7.59 × 10⁻⁶ | 1110 | 2.4 |
| Ti₉₉Cr₁ | 0.909 | 12.97 × 10⁻⁶ | 1035 | 4.2 |

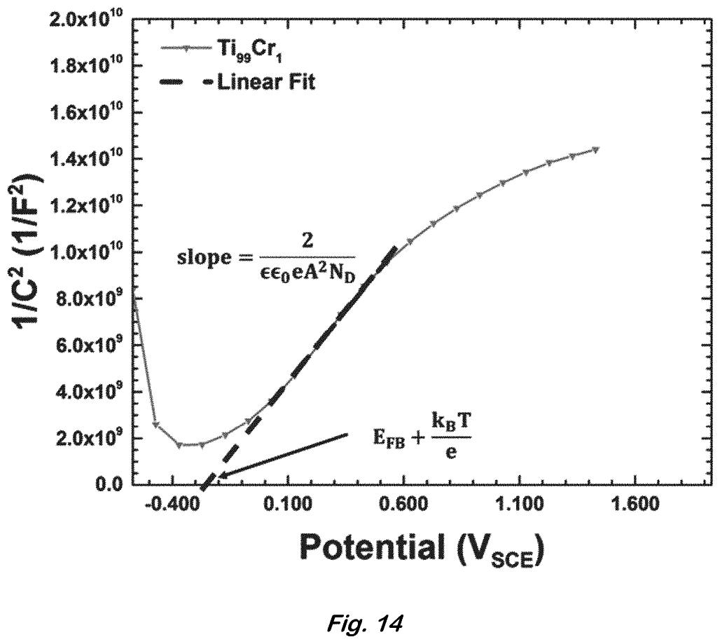

In order to address how the electronic structure of the oxide affects reduction reaction kinetics, the Mott-Schottky relationship (Mantia et al., “A critical assessment of the Mott-Schottky analysis for the characterization of passive film-electrolyte junctions” Russian Journal of Electrochemistry, vol. 11, pp. 1306-1322, 2010; Azumi et al., “Mott-Schottky plot of the passive film formed on iron in neutral borate and phosphate solution” Journal of the Electrochemical Society, vol. 134, pp. 1352-1357, 1987), Eq. (6), was employed to determine the flatband potential of the oxides of the pure titanium and binary alloy oxides.

$$\frac{1}{{C}^{2}} = \frac{2 * ( {V}_{app} - {E}_{FB} - \frac{{k}_{B} T}{e} )}{{ϵϵ}_{0} {eN}_{D} {A}^{2}} \qquad ( 6 )$$

where E_{FB} is the flatband potential, C is the interfacial capacitance, e is the charge on the electron, A is the interfacial contact area, ε is the dielectric constant of the oxide, ε₀ is vacuum permittivity, and Vₐₚₚ is the externally applied potential. The Mott-Schottky equation proposes an inverse relationship between capacitance and applied potential with the slope related to the donor concentration, N_{D}. An example of the analysis for Ti₉₉Cr₁ is presented in FIG. 14.

The dielectric constants, ε, for the oxides can be obtained from Eq. (7).

$$C = \frac{{ϵϵ}_{0} A}{D} \qquad ( 7 )$$

where C is the capacitance, ε is the dielectric constant of the oxide, ε₀ is vacuum permittivity, and A

is the exposed area, and D is the oxide thickness. The exposed areas were roughly 0.20 cm² and the oxide thickness was estimated to be 2 nm. From the equivalent CPE circuit fits in FIG. 13 the dielectric constants in Table 3 were obtained.

TABLE 3
Calculated dielectric constants for the metal oxides.

| Metal Oxide | Capacitance (μF) | Dielectric Constant |
|---|---|---|
| Pure Ti | 8.4 | 97 |
| Ti₉₉Co₁ | 2.7 | 31 |
| Ti₉₉Sn₁ | 2.4 | 28 |
| Ti₉₉Cr₁ | 4.2 | 48 |

The donor concentration can be obtained from the following equation:

$$Slope = \frac{2}{{ϵϵ}_{0} {eA}^{2} {N}_{D}} \qquad ( 8 )$$

where the slope is from the linear best-fit line to the 1/C² vs. potential plot for each oxide from the Mott-Schottky measurements, as shown in FIG. 14. The flatband potential can be obtained from the following:

$${V}_{app} = {E}_{FB} + \frac{{k}_{B} T}{e} \qquad ( 9 )$$

The donor concentration values suggest the oxidation states shown in Table 4 for the oxide components. The oxidation states imply that the three alloying elements to the bulk Ti: Co, Sn, and Cr, are all p-type dopants in the oxides.

TABLE 4
Estimated oxidation states for the elements
comprising the various oxides.

| Element | Oxidation State |
|---|---|
| O | −2 |
| Ti | +4 |
| Co | +3 |
| Sn | +2 |
| Cr | +3 |

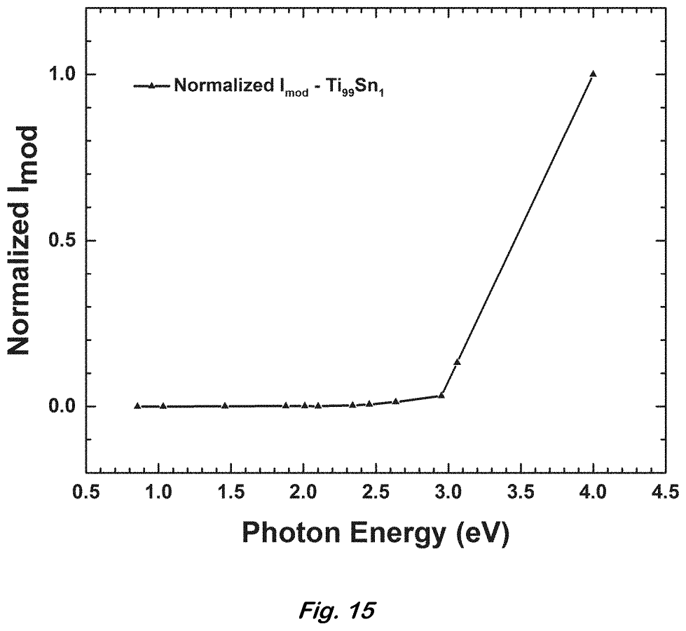

The flatband potentials (Table 5) fix the lower bound of the conduction band in the oxides but the band gaps are also needed to determine the top edge of the valence bands. The response of the oxide films to the IMPS experiments, as shown in FIG. 10, can be used to determine the band gaps. FIG. 15 shows a plot of normalized Imod for Ti₉₉Sn₁. That is, the maximum I_{mod} value was normalized to 1.0 and that ratio was applied to the other I_{mod} values. The I_{mod} values were obtained from the oxide film response to incident on-off light at 0.1 Hz.

TABLE 5
Values for E_{FB}, the flatband potential, and the dopant concentration,
N_{D}, determined from the analysis of the Mott-Schottky tests performed
on the pure titanium oxide and oxides of titanium alloys.

| Metal Oxide | E_{FB} (V_{SCE}) | N_{D} (cm⁻³) |
|---|---|---|
| Pure Ti | −0.31 | 7.0 × 10²¹ |
| Ti₉₉Co₁ | −0.19 | 5.6 × 10²¹ |
| Ti₉₉Sn₁ | −0.18 | 13 × 10²¹ |
| Ti₉₉Cr₁ | −0.24 | 6.3 × 10²¹ |

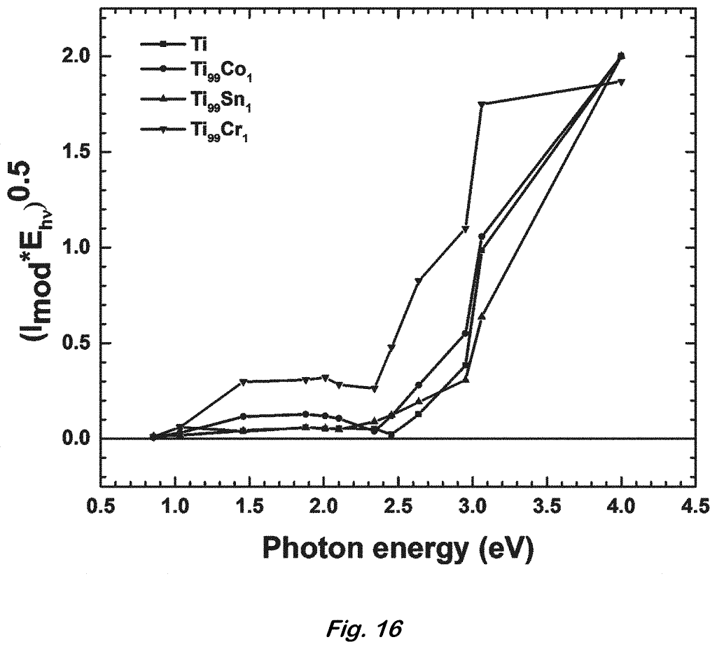

The plot in FIG. 15 suggests a smaller band gap than the band gap of 3.0 eV (Birch et al., “Oxides formed on titanium by polishing, etching, anodizing, or thermal oxidizing” Corrosion, vol. 56, pp. 1233-1241, 2000) for rutile TiO₂. Following the approach in Goosens (“Intensity-modulated photocurrent spectroscopy of thin anodic films on titanium” Surface Science, vol. 365, pp. 662-671, 1996), the band gaps were determined from the x-intercepts of the linear best-fit lines to plots of (I_{mod}×Eₕᵥ)^{0.5} vs. photon energy, as shown in FIG. 16.

The top of the valence band energies can then be obtained by subtracting the band gap energy from the bottom of the conduction band energies, with the results shown in Table 6.

TABLE 6
Values for the band gap energies and valence band energies
for titanium oxide and the oxides of the titanium alloys.

| Metal Oxide | E_{g} (eV) | E_{VB} (V_{SHE}) |
|---|---|---|
| Pure Ti | 2.90 | 2.59 |
| Ti₉₉Co₁ | 2.82 | 2.63 |
| Ti₉₉Sn₁ | 2.88 | 2.70 |
| Ti₉₉Cr₁ | 2.78 | 2.54 |

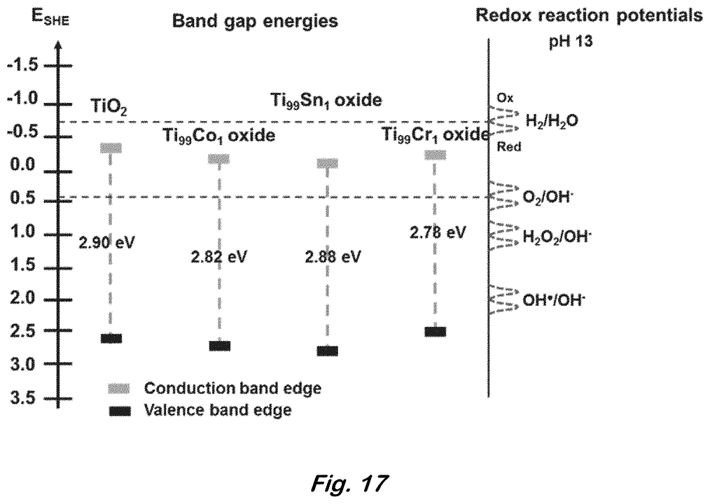

The above analysis can be summarized in the chart shown in FIG. 17 in which the band energies of the various oxides are overlaid on redox reaction potentials of reduction reactions that can be catalyzed on the oxides. In contrast to what was observed elsewhere (Goosens, “Intensity-modulated photocurrent spectroscopy of thin anodic films on titanium” Surface Science, vol. 365, pp. 662-671, 1996), Table and FIG. 17 indicate that the band gap energy for the pure TiO₂ is close to the accepted value of 3.0 eV for rutile TiO₂. However, the band gap energies for the oxides on the low-alloyed titanium are slightly smaller than 3.0 eV. This reduction may occur because the dopant atoms can act as strain relief centers for the TiO₂ while providing electron acceptor states within the band gap. In addition, the conduction and valence band edges are shifted as a result of the alloying indicating that the H₂/H₂O reaction from Table 1 will not occur on these oxides at this pH at the equilibrium potential (Ma et al., “Titanium dioxide-based nanomaterials for photocatalytic fuel generations” Chemical Reviews, vol. 114, pp. 9987-10043, 2014).

The chart in FIG. 17 indicates that even low concentrations of alloying elements in metallic titanium can alter the electronic structure of the oxide that forms on the metal surface and suggests that, from a thermodynamic standpoint, there are other surface states available on the oxides that can compete with the oxygen reduction reaction (ORR) for collection of electrons supplied by oxidation reactions.

Measurements of the oxygen reduction reaction kinetics on each of the oxide surfaces, as shown in FIG. 12, indicate that the ORR is suppressed by the addition of these alloying elements. For example, at −0.9 V_{SCE}, a potential at which the oxygen reduction reaction would occur on these oxides, the currents obtained from the RDE experiments, shown in Table 7, suggest that the cathodic current can be suppressed up to 99% in a high pH environment.

TABLE 7
Reduction currents measured during RDE experiments on each
oxide at −0.9 V_{SCE}, at 1600 rpm rotation speed in 0.6M
NaCl + 0.01M KOH and compared to the baseline of the pure TiO₂.

| | Potential | Reduction current | |
|---|---|---|---|
| Oxide | (V_{SCE}) | (μA/cm²) | % change |
| Pure Ti | −0.9 | −414 | 0 |
| Ti₉₉Co₁ | −0.9 | −173 | −58 |
| Ti₉₉Sn₁ | −0.9 | −14 | −97 |
| Ti₉₉Cr₁ | −0.9 | −6 | −99 |

These data suggest that the presence of these alloying elements in the oxide disrupt its catalytic capability. A similar trend is seen in the Nyquist plot of the IMPS results in FIG. 11, with the lowest response also occurring on the oxide of the Ti₉₉Cr₁ alloy.

Computational modeling predicted that Mn and Al would bring the highest ORR overpotentials of the cases considered and thus would be the best dopants for suppressing ORR activity and corrosion. Co, Sn, and Cr in turn should be moderate inhibitors, and Nb and Ag should increase ORR activity relative to pure amorphous TiO₂. This is consistent with previous work by Arashi and coworkers that showed Nb doped amorphous TiO₂ has a slightly lower overpotential than the undoped material (Arashi et al., Catal. Today 2014, 233, 181-186). Vanadium is a more challenging dopant to characterize because it has two stable oxidations states V³⁺ and V⁵⁺ that lie near the experimental conditions. Thus, V dopants are likely present as a mixture of V³⁺ and V⁵⁺. At more negative applied potentials, the ratio of V³⁺/V⁵⁺ should increase to favor V³⁺ and the ORR activity of the oxide should decrease. This suggests that different dopants could have different capacities to suppress corrosion at different applied potentials in the experiments. The Pourbaix diagrams for all other considered dopants have only one stable oxidation state near the experimental conditions. Trends for seven dopants were experimentally verified, but Ga, Zn, and Si were also computationally predicted to destabilize ORR intermediates on the surface and potentially result in even better ORR inhibition than Al and Mn.

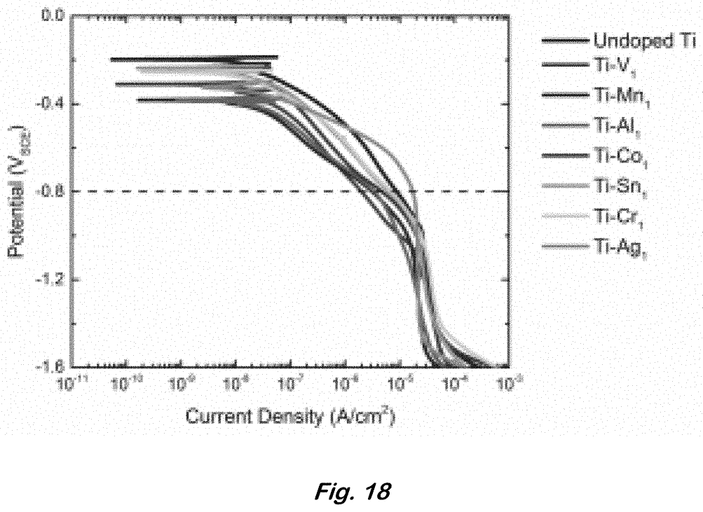

FIG. 18 shows the cathodic polarization scans for all of the alloys. The current density values at −0.8 VSCE, a value in keeping with galvanic corrosion potentials between Ti and Al alloys, were taken for at least three replicates and then averaged. The percent change for each alloy with respect to the undoped Ti is shown in Table 8. Previous X-ray photoelectron spectroscopy studies have indicated that the dopant metal is present in the oxide (Policastro et al., J. Electrochem. Soc. 2016, 163, C269-C274).

TABLE 8
Percent change in current at −0.8 VSCE
of alloy samples versus the undoped Ti

| | Current density | |
|---|---|---|
| Alloy | (μA/cm²) | % change |
| Ti | 8.8 | — |
| Ti₉₉V₁ | 2.0 | −77 ± 3 |
| Ti₉₉Mn₁ | 3.1 | −65 ± 4 |
| Ti₉₉Al₁ | 3.4 | −61 ± 11 |
| Ti₉₉Co₁ | 4.7 | −47 ± 5 |
| Ti₉₉Cr₁ | 6.2 | −30 ± 8 |
| Ti₉₉Sn₁ | 6.9 | −21 ± 11 |
| Ti₉₉Ag₁ | 17.3 | +95 ± 13 |

The quantum chemistry predictions almost exactly mirror the experimental results. The trend in dopant performance predicted by computational modeling was:

Ag>undoped>Sn>Co>Cr>Al>Mn>V

while experimental linear sweep voltammetry measurements found almost exactly the same ranking:

Ag>undoped>Sn>Cr>Co>Al>Mn>V

The model appears to overestimate the effect of Cr relative to Co, but these fall quite close on the volcano plot within 0.2 eV. This signifies that not only are Sabatier analyses useful for discerning materials with high catalytic activity (as is done for fuel cell catalysis), but such modeling is also robust enough to identify dopants for materials having low catalytic activities.

The ability of the dopant atoms to bind the ORR intermediates was hypothesized to correlate with the total charge of each intermediate after it is bound to the surface. Bader charge analysis shows that *OOH bound to Al³⁺, Ag⁺, Mn²⁺, or V³⁺has a charge of −0.70, −0.86, −1.02, or −1.05, respectively. Note that dopants with larger degrees of charge transfer would bind the intermediates more tightly, and thus more effectively poison the surface for chemical reactions. Dopants falling on the left side of the activity volcano and their overpotentials are due to the energy required to remove *OH from the surface (Eq. (4)). This is similar to the findings of Markovic et al. (Nat. Chem. 2009, 1, 466-472) who showed that electrolyte ions can (de)stabilize *OH on the surface and alter ORR rates by an order of magnitude. On the other hand, dopants that transfer too little charge will form weaker bonds that are not strong enough to form reaction intermediates. The overpotential of these dopants is determined by the energy required to form *OOH (Eq. (1)), and they are located on the right side of the activity volcano.

For dopants with intermediate oxidation states (i.e. V³⁺, Mn²⁺, Cr³⁺, Co²⁺, and AG⁺), the ability to donate electron density appears to correlate with their approximate redox potentials from Pourbaix diagrams in the literature (V₂O₃ [symbol] V₃O₅ at E⁰=−0.5 VSHE, Mn³⁺ [symbol] Mn₂O₃ at E⁰=0.3 VSHE, Cr₂O₃ [symbol] CrO₄²⁻ at E⁰=0.2 VSHE, CoO [symbol] Co₃O₄ at E⁰=1.0 VSHE, and Ag⁺ [symbol] Ag₂O₃ at E⁰=1.2 VSHE (Takeno, Geological survey of Japan open file report 2005, 419, 1-102)). For dopants at their highest oxidation state, (i.e. Nb⁵⁺, Ti⁴⁺, Sn⁴⁺, and Al³⁺) the ability to bind to ORR intermediates correlates surprisingly well with the calculated atomic radii of the dopants (Nb=1.98 Å, Ti=1.76 Å, Sn=1.45 Å, and Al=1.18 Å). Bonding orbitals in smaller dopants (such as Sn and Al) have less orbital overlap which makes it more difficult to transfer electron density to the adsorbed intermediates than larger dopants (such as Nb). This results in weaker bonds and higher overpotentials. Although this trend might be coincidental, Ge, Zn, Ga, and Si all have atomic radii similar to Al (Ge=1.25 Å, Zn =1.42 Å, Ga=1.36 Å, and Si=1.11 Å) which is consistent with the predictions that these dopants may indeed suppress ORR activity more than Al and Mn.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A method comprising:
providing an article comprising:
a composition comprising:
an alloy having the formula Ti₁₋ₓMₓ;
wherein M is a dopant selected from Co, Sn, Cr, and combinations thereof; and
wherein x is from 0.001 to 0.02; and
an oxide of the alloy comprising the dopant on a surface of the article;
positioning the article in electrical contact with a metal component; and
positioning the article in contact with an electrolyte that is in contact with the metal component;
wherein the metal component has a lower electrode potential in the electrolyte than titanium.

2. The method of claim 1;
wherein M is Co, Sn, or Cr; and
wherein x is from 0.005 to 0.015.

3. The method of claim 1, wherein the composition comprises at least 90 wt % of the alloy.

4. The method of claim 1, wherein the composition comprises at least 99 wt % of the alloy.

5. The method of claim 1, wherein the article is a fastener.
